(19) United States
(12) Patent Application Publication
(10) Pub. No.: US 2024/0237684 A1
(43) Pub. Date: Jul. 18, 2024

(54) FERMENTED FOOD PRODUCTS

(71) Applicant: EIGHTH DAY FOODS HOLDINGS PTY LTD, Coburg North (AU)

(72) Inventors: Roger David DREW, Coburg North (AU); Janine Mary DREW, Coburg North (AU)

(73) Assignee: EIGHTH DAY FOODS HOLDINGS PTY LTD, Coburg North (AU)

(21) Appl. No.: 18/289,523

(22) PCT Filed: May 5, 2022
(86) PCT No.: PCT/AU2022/050420

§ 371 Date: Nov. 3, 2023

(30) Foreign Application Priority Data
May 5, 2021 (AU) 2021901345

(51) Int. Cl. A23L 11/50; A23L 5/10; A23L 5/40; A23L 11/00; A23L 25/00; A23L 27/00

(52) U.S. Cl. CPC A23L 11/50; A23L 5/13; A23L 5/15; A23L 5/40; A23L 11/05; A23L 25/20; A23L 27/82; A23L 27/88

(57) ABSTRACT

Disclosed herein are fermented food products and a method for producing fermented food products from a pulse. The method comprises the steps of cooking the pulse, wherein the pulse is provided in the form of flattened pulse fragments, and then fermenting the cooked flattened pulse fragments under conditions whereby the fermented food product is produced.

### TECHNICAL FIELD

The present invention relates to methods for producing fermented food products and to the resultant food products. In a particular form, the invention relates to fermented lupin food products.

### BACKGROUND ART

Solid state fermentation has traditionally been used to make tempeh from soybeans. This natural culturing and controlled fermentation process uses a fungus such as Rhizopus oligosporus and results in the soybeans being bound into a cake form by the mycelium that grows. Briefly, whole soybeans are boiled and dehulled and then softened by soaking, before being partly cooked, drained and cooled. The partially cooked soybeans are then mixed with a fermentation starter containing the spores of fungus such as Rhizopus oligosporus and the beans spread into a thin layer, where they are allowed to ferment for 24 to 36 hours at a temperature of about 30° C. During this time, the spores germinate and there is an abundant growth of mycelium, resulting in the soybeans being bound into a solid mass by a mat of white mycelium. The resultant tempeh is a staple food in some countries (primarily Indonesia), but is not widely consumed elsewhere due to its undesirable mouthfeel, unfamiliar organoleptic properties and unusual cooking properties.

Solid-state fermented food products formed from legumes other than soybeans are known. However, such products are often nutritionally inferior to soybean tempeh, and can have an undesirable mouthfeel or other organoleptic properties. For example, fermented lupin food products are known. Lupins have many superior nutritional properties over soybeans (and other pulses) such as a high protein and fibre content, as well as low carbohydrate content, and fermented lupin food products might be thought of as being a desirable food product. However, all of the solid-state fermented lupin food products of which the inventors are aware have an undesirable mouthfeel, unfamiliar organoleptic properties and unusual cooking properties.

Given the relatively high cost to the environment of producing meat-based food products, plant-based food products are becoming an ever more viable alternative. Many plant-based food products, however, are highly processed and have little health benefit. Solid-state fermentation has long provided an alternative quality protein source, but the resultant food product's organoleptic, functionality and cost/time of production (and nutrition) have limited their widespread use.

It would be advantageous to provide an alternative method for producing fermented food products from pulses (such as lupins), and ideally methods which result in nutritional, functional and palatable food products.

### SUMMARY OF THE INVENTION

In a first aspect, the present invention provides a method for producing a fermented food product from a pulse (e.g. lupins, soyabeans, chickpeas, lentils, beans, peas or peanuts). The method comprises the steps of cooking the pulse, the pulse being provided in the form of flattened pulse fragments, and then fermenting the cooked flattened pulse fragments under conditions whereby the fermented food product is produced.

The present invention arises from the discovery by the inventors that using lupin fragments having a particular size and shape, instead of whole or cracked lupins, in a solid state fermentation process surprisingly resulted in a fermented lupin food product having pleasing organoleptic properties and good functionality. Conventional wisdom teaches that tempeh (and hence other fermented food products) should be produced from whole beans, given the process traditionally used to produce tempeh. However, the inventors have discovered that this need not be the case. The inventors have discovered that the flattened pulse fragments described herein can be used to produce fermented food products in a solid state fermentation method that have high nutritional content, good functionality and unexpectedly pleasing organoleptic properties such as mouthfeel.

The inventors have also found that using lupin, soybean and mung bean fragments having the defined size and shape (i.e. instead of whole lupins etc.) uniformly increases the surface area and thus increases penetration of mycelium during fermentation, enabling more effective hydrolysation of proteins, lipids and carbohydrates. Fermented pulse food products produced in accordance with the present invention have been found to have a stronger bond and pliability, enabling the products to be more finely cut, better minced and more easily moulded into shapes. The resulting simpler and shorter manufacturing process enables more affordable production, less equipment and less waste for all pulse-containing fermented food products of the present invention.

Furthermore, fragments of lupins and other pulses are able to be cooked more rapidly than whole lupins (etc.), which the inventors have found results in little or no leaching of nutrients. Hence, the fermented food products of the present invention can have an improved nutritional profile compared to other commercially available products that require soaking or prolonged cooking.

In some embodiments, the flattened pulse fragments may have a thickness of between about 0.5 mm and about 1.3 mm (e.g. about 1 mm). In some embodiments, the pulse fragments may have a length of between about 2.5 and about 7 mm (e.g. about 3.5 mm) and a width of between about 1.5 and about 5 mm (e.g. about 2.5 mm). Such embodiments, described in further detail below, result in fermented food products which the inventors believe are far superior to all other pulse-containing fermented food products which they have sampled (particularly for lupins and soybeans).

In some embodiments, the flattened pulse fragments may be cooked by blanching. The inventors have found, for example, that blanching flattened lupin fragments for about 5 minutes adequately cooks the fragments but without too deleteriously affecting the fragments' nutrient content.

In some embodiments, the flattened pulse fragments may be cooked by heating, for example in an oven and to a temperature of about 100° C. In some embodiments, the flattened pulse fragments may be cooked by heating, for example in an oven at a temperature of about 100° C. and about 100% relative humidity (r/h). In some embodiments, the fragments may undergo a short hydration before heating, for example by being immersed briefly in near-boiling water.

In some embodiments, the method may further comprise adding a pH reducing agent (e.g. white rice vinegar) pre-fermentation in order to reduce the pH of the mixture in order to reduce unwanted pathogens and aid fermentation. The inventors note that maintaining pH below about 5 (e.g. below 4.7) can also help to maintain a high proportion of protein in the solids during the cooking step, proteins generally remaining insoluble at such a pH.

In some embodiments, fermentation may be caused to begin by adding a fermentation starter (e.g. Rhizopus oligosporus, Rhizopus oryzae, Rhizopus arrhizus and/or Rhizopus stolonifer) to the cooked flattened pulse fragments. Fungal fermentation of the cooked flattened pulse fragments in the process of the present invention is similar to that of traditional tempeh making processes.

In some embodiments, the method may further comprise adding a colourant in order to produce a coloured fermented food product. Advantageously, the inventors have found that such a colourant may be added pre-fermentation, which is another surprising advantage over traditional solid state fermentations, where colourants are usually only added after fermentation (when they cannot effectively diffuse throughout the product, resulting in an inconsistent colouring).

In some embodiments, the method may further comprise adding a flavourant in order to produce a flavoured fermented food product. The inventors have found that such a flavourant can also be added pre-fermentation, another surprising advantage over traditional solid state fermentations, where flavourants are usually only added after fermentation (when they cannot effectively diffuse throughout the product, resulting in an inconsistent flavouring).

The inventors have found that adding flavouring and/or colourants pre-fermentation has surprisingly proven possible, enabling a fermented consumable food product that wholly embodies the colours and flavours evenly and consistently throughout the product (a highly desirable property for meat-alternatives) and does not require colouring or flavouring post-fermentation or by the consumer.

In some embodiments, the method may further comprise adding one or more seeds selected from the following group into the fermented food product: quinoa, amaranth, buckwheat, pumpkin seeds, hemp seeds and sunflower seeds. Such additional seeds may provide an enhanced nutritional value, taste or mouthfeel.

In a second aspect, the present invention provides a fermented food product (e.g. a fermented lupin food product) produced by the method of the first aspect of the present invention.

In a third aspect, the present invention provides a food product including a fermented food product produced by the method of the first aspect of the present invention.

In a fourth aspect, the present invention provides fermented food product comprising fermented flattened pulse fragments.

Other aspects, embodiments and advantages of the present invention will be described below.

### DESCRIPTION OF EMBODIMENTS

The present invention provides a method for producing a fermented food product from a pulse. The method comprises the steps of cooking the pulse, wherein the pulse is provided in the form of flattened pulse fragments and then fermenting the cooked flattened pulse fragments under conditions whereby the fermented food product is produced.

Fermented food products produced via this method, and food products including the fermented food product produced by this method, are also provided.

The present invention will be described below primarily in the context of fermented lupin food products, although it is to be appreciated that the invention has general applicability to all pulses that can be fragmented and flattened in accordance with the invention for subsequent fermentation. Other pulses which the inventors expect can be utilised in the methods of the present invention include, for example, soyabeans, chickpeas, lentils, beans, (e.g. black beans, mung beans, etc.), peas or peanuts. Essentially, the inventors believe that their invention will be applicable for any legume/pulse which is fragmentable, flattenable and fermentable as described herein. It is within the ability of a person skilled in the art to ascertain this for any given pulse.

In some embodiments, the method of the present invention may include two or more of the pulses described above.

Fermented food products, such as fermented lupin food products, produced in accordance with the present invention may be cooked and consumed as is, or may be further processed into other food products. For example, the fermented lupin food products may be coated with a material such as breadcrumbs to provide a crunchy outer coating upon frying. The fermented lupin food products may be ground up and re-set in order to produce a food product that mimics a beef patty. The fermented lupin food products may be produced in a shape that mimics other foods, such as a fish fillet or a sausage, for example.

The method of the present invention includes cooking the pulse, where the pulse is provided in the form of flattened fragments of the pulse. As described above, the size and shape of the pulse fragments is important because it enables the production of improved fermented food products that do not suffer from the undesirable attributes of presently available fermented food products.

The flattened pulse fragments may be obtained from a commercially available source or may be produced on site in a pre-cooking step in which the pulses are fragmented using any suitable technique. For example, whole lupins may be fragmented using any suitable technique to produce particles of what are referred to herein as “lupin fragments” (or, more generally, “pulse fragments”). In the specific embodiments described below, lupin fragments are obtained by running lupins between rollers (fluted or smooth), however it will be appreciated that many other conventional techniques could be used to perform this function.

The pulse fragments may have a substantially consistent size, which will ensure substantial homogeneity in the fragments' properties, although this need not always be the case, and pulse fragments having a relatively wide range of particle sizes (i.e. in the context of the present invention) may be used in some embodiments.

The length, width and thickness of the flattened pulse fragments are important for achieving the advantageous effects of the present invention. Generally speaking, the width, length and thickness of the fragments undergoing fermentation enables aerobic fermentation to occur whereby the pleasing organoleptic properties such as texture and mouthfeel described above are imparted to the final product. Any dimensions of the pulse fragments that achieve such are within the scope of the present invention and, in light of the teachings contained herein, can be determined through straightforward trial and experimentation. The type of pulse and desired attributes of the resultant fermented food product will be two of the primary factors affecting these parameters.

In some embodiments, the flattened pulse fragments may have a length of between about 2.5 mm and about 7 mm, e.g. between about 2.5 mm and about 5 mm, between about 3 mm and about 4.5 mm between about 3.5 mm and about 4.5 mm or between about 3 mm and about 4 mm. In some embodiments, the flattened pulse fragments may have a length of about 2.5 mm, 3 mm, 3.5 mm, 4 mm, 4.5 mm, 5 mm, 5.5 mm, 6.0 mm, 6.5 mm or 7 mm. In some embodiments, the flattened pulse fragments may have a width of between about 1.5 mm and about 5 mm, e.g. between about 1.5 mm and about 3 mm, between about 2 mm and about 3 mm between about 2 mm and about 2.5 mm or between about 2.5 mm and about 3 mm. In some embodiments, the flattened pulse fragments may have a width of about 1.5 mm, 2 mm, 2.25 mm, 2.5 mm, 3 mm, 3.5 mm, 4.0 mm, 4.5 mm or 5.0 mm.

As used herein, the term “about” is to be understood to mean that the specified dimension may vary slightly, for example by ±10%.

The pulse fragments obtained as described above are flattened in order to provide the advantageous shape which the inventors have discovered results in their novel fermented food products having the advantageous features described above. The inventors note that the selection of a specific flake/fragment size and shape at the outset of a solid state fermentation process is not routine in the art and would, in no way, be expected to have such an effect on the organoleptic properties of the finished fermented product.

Any suitable technique may be used to flatten the pulse fragments. In the specific embodiments described below, for example, lupin fragments are flattened by traversing between two rollers having a predefined space therebetween (e.g. having a spacing of about 1 mm in the case of a 2 mm thick kibble). Similar apparatus can be used to flatten other pulses or pulse fragments. As noted above, the inventors surprisingly discovered that fermented lupin food products produced from such rolled lupin fragments did not have the grainy mouthfeel of fermented lupin food products produced with non-rolled lupins.

The thickness of the flattened pulse fragments may be adjusted in the solid state fermentation in order to impart variable organoleptic properties etc. on the resultant food product. It is within the ability of a person skilled in the art, in light of the teachings contained herein and perhaps with some routine trial and experimentation, to determine the most appropriate thickness for any given pulse and subsequent food product. In some embodiments, for example, the flattened pulse fragments may have a thickness of between about 0.5 mm and about 1.3 mm, between 0.6 mm and about 0.9 mm, between 0.7 mm and about 1.1 mm or about 0.9 mm and 1 mm. In some embodiments, for example, the flattened pulse fragments may have a thickness of about 500 μm, 550 μm, 600 μm, 650 μm, 700 μm, 750 μm, 800 μm, 850 μm, 900 μm, 950 μm, 1 mm, 1.1 mm, 1.2 mm or 1.3 mm.

The inventors note that it might also be possible to use fragmented particles having a thickness of less than 500 μm, particularly if a conditioning step (similar to that used for rolled oats) was applied just prior to flaking/rolling rather than simple dry-rolling. Such might result in an even finer texture in the resultant fermented food product.

The inventors also note that, for smaller pulses, it may not be necessary to fragment the pulse before it is flattened. Again, it is within the ability of a person skilled in the art, in light of the teachings contained herein, to determine whether a fragmentation step is required.

In some of the embodiments described in further detail below, the flattened lupin fragments had a thickness of 950 μm, a length of 3500 μm and width of 2250 μm. No more than 3% of the flattened lupin fragments passed through 800 μm sieve.

Tempeh production generally involves dehulling of the soybeans (which may otherwise compromise the fermentation) and this is also the case for the method of the present invention, although it is an option to not do so if the hulls may provide some advantageous property or functionality. The pulses may be dehulled at any stage of the process, with dehulling before milling being a convenient time to do so.

The pulse fragments provided in the form of flattened pulse fragments are cooked in the first step of the present invention. Any suitable technique for cooking the flattened pulse fragments may be used, with the length of cooking time and the heat applied generally determining the degree to which the pulse is cooked. The degree to which the flattened pulse fragments are cooked will depend on factors such as the type of pulse being used, the dimensions of the pulse fragments and the desired properties of the produced fermented food product. Generally speaking, if the flattened pulse fragments are undercooked, the mycelium cannot adequately penetrate the mixture and, if the flattened pulse fragments are overcooked, the particles collapse creating anaerobic conditions during fermentation. In the case of flattened lupin fragments having the size described in the Examples, for example, undercooking would result in inadequate penetration of mycelium, resulting in a lower metabolic transformation, and overcooking would result in particles not being able to hold their form, causing them to collapse and resulting in inadequate aerobic conditions and poor fermentation. Again, it is within the ability of a person skilled in the art, in light of the teachings contained herein and perhaps some routine trial and experimentation, to determine appropriate cooking conditions (e.g. method, temperature, time, etc.) for any given flattened pulse fragments and subsequent food product.

In some embodiments, the flattened pulse fragments may be cooked by blanching. Blanching involves immersing the flattened pulse fragments into boiling water (or exposing them to steam) for a period of time, followed by draining and drying in order to stop them from cooking further. In some of the embodiments described in further detail below, flattened lupin fragments having the described dimensions were blanched for about 5 minutes. As will be appreciated, relatively short cooking times, such as those described herein, would result in food products having an increased nutritional content compared to products produced with methods that include relatively long cooking times.

The time required to cook the flattened pulse fragments by blanching will depend on factors such as the type of pulse(s), the fragment size and the desired attributes of the resultant fermented food product. Generally speaking, dwell times of from about 3 to about 10 minutes should be effective. In the embodiments described in further details below, the lupin fragments were blanched for 5½ minutes.

In some embodiments (especially where cooking involves immersion in water or steam), it may be advantageous to dewater the cooked flattened pulse fragments pre-fermentation. Fermented food products having an unsatisfactory consistency may be produced if the cooked fragments are too watery. Too much water might also hinder the fermentation process by creating anaerobic conditions.

In such embodiments, any suitable dewatering method may be used to reduce the moisture content of the cooked fragments. For example, the moisture content of the cooked fragments may be reduced by squeezing the cooked fragments between rollers. The moisture content of the cooked fragments may be reduced by any amount, depending on the particular method and desired product. In some embodiments, for example, the moisture content of the cooked fragments may be reduced by about half.

The moisture content of the partially cooked flattened pulse fragments may, for example, be reduced by air drying, pressure or spinning, in the same chamber as where blanching occurred, if the chamber is capable of such. In the embodiments described below, the post-blanch hydrated weight of the cooked lupin fragments is between 184% and 244% (e.g. 204%) of the weight of the original lupin fragments.

The inventors note that using the blanching method described above can result in overhydration and the subsequent necessity of spin drying the cooked pulse fragments, which inevitably results in a loss of some nutrients.

In some embodiments, the flattened pulse fragments may be cooked by heating, for example in an oven and to a temperature of about 100° C. In some embodiments, the fragments may undergo a short hydration before heating, for example by being immersed briefly in near-boiling water.

In specific embodiments trialed by the inventors, flattened lupin fragments underwent a short hydration in near-boiling water (95° C.) for between 15 and 35 seconds, depending on the thickness of the pulse flake. The fragments were then cooked in an oven for 6-10 minutes at 100° C. and 100% R/H. The cooked fragments were then allowed to cool to about 30° C., either prior to or during blending,

Once the flattened fragments have been at least partially cooked, they are fermented under conditions which result in the fermented food product being produced. The fermentation method of the present invention is similar to that of the conventional solid state fermentations, such as the tempeh producing process and can readily be adapted as necessary, and in light of the teachings contained herein, by a person skilled in that art.

Typically, fermentation is caused to begin by adding a Rhizopus culture starter to the cooked flattened pulse fragments (either after they have cooled or whilst they are cooling, provided the fermentation will not be adversely affected by the elevated temperature of the cooked flattened pulse fragments). The fermentation starter may be added to the cooked lupin fragments in any effective manner and typically involved blending of the two components in order to ensure an even distribution of the starter through the material. Any suitable Rhizopus culture starter may be used, including Rhizopus oligosporus, Rhizopus oryzae, Rhizopus arrhizus and Rhizopus stolonifer, all of which are used in conventional solid state fermentations.

Once so-mixed, fermentation begins to occur. Typically, fermentation is allowed to continue for between about 22 to 30 hours (e.g. 26 hours, in the case of the lupin fermented food products described below), whist the temperature is maintained about 30° C. and the humidity maintained at about 40-75%.

The mixture of Rhizopus culture starter and at least partially cooked flattened pulse fragments may be allowed to ferment in a mould, which would result in fermented food products having a predefined shape. Such may be advantageous, for example, if the fermented food product is intended for subsequent use as an imitation food product (e.g. an imitation sausage or fish fillet).

The present invention may also optionally include other ingredients, provided that such do not deleteriously affect the invention.

For example, in some embodiments, the method may further comprise adding a pH reducing agent pre-fermentation. A pH reducing agent will reduce the pH of the cooked fragments to a value where growth of Rhizopus mold (for example) is encouraged but growth of unwanted pathogens is discouraged. The pH level should generally be kept around 4-5 prior to fermentation in order to retain a high proportion of protein in the flattened pulse fragments during the cooking step, proteins generally remaining insoluble at such a pH.

Any food grade ingredient that will reduce the pH and not otherwise deleteriously affect the invention may be used. Examples of suitable pH reducing agents include pasteurised vinegars such as white rice vinegar, lactic acid, citric acid or acetic acid.

In some embodiments, the method may further comprise adding a colourant and/or a flavourant in order to colour/flavour the resultant fermented food products. As noted above, the inventors have surprisingly found that a colourant/flavourant can be added at any stage of the method, which is in contrast to other solid state fermentations. Adding a colourant/flavourant to the mixture pre-fermentation enables a far more intimate mixing throughout than is possible at later stages. Consistently-coloured/flavoured food products can thus be produced, without need for the use of flavoured coatings to improve palatability, enabling a fermented consumable food product that embodies said colours and flavours (a highly desirable property for meat-alternatives) and does not require colouring or flavouring post-fermentation or by the consumer.

Any food grade colourant and/or a flavourant may be used in the present invention. Examples of suitable colourants include beetroot powder. Examples of suitable flavourants include turmeric, paprika, nori and dried or fresh mushroom.

Other seeds may also be blended into the fermented food product, provided this does not deleteriously affect the present invention. Such seeds may, for example, be selected from the following: quinoa, amaranth, buckwheat, pumpkin seeds, hemp seeds and sunflower seeds. Such seeds my impart improved taste, nutritional attributes or functionality to the resultant food product, and may be added at any suitable stage in the method of the invention.

Also disclosed herein is a fermented food product (e.g. a fermented lupin food product) that is characterised by comprising (or, in some embodiments, consisting only of) fermented flattened pulse fragments. Such a fermented food product may be produced using the methods described above, although it need not be. For example, the pre-fermentation steps in the production method may take any form that results in a fermentable material.

### EXAMPLES

Examples of specific embodiments in accordance with the present invention will now be described.

### Example 1

The following example describes a method used to produce a lupin fermented product.

Dehulled and Sweet white (albus) lupins were provided in the form of fragments that had been milled into particles having a length of approximately 3500 μm a width of approximately 2250 μm and flattened to a thickness of approximately 950 μm. 100 g of these flattened lupin fragments were immersed in boiled water, to which 6 g-10 g of white rice vinegar had been added to adjust the pH to below 4.0.

The lupin fragments were blanched in the boiled water for 5 minutes and 30 seconds, ensuring pH remained below pH: 4.7, before being squeezed to expel excess water to a weight of 214 g. The pH was maintained at less than pH 4.7 in order to retain a high proportion of protein in the solids, proteins generally remaining insoluble at such a pH. The lupin fragments were then air-dried to approximately 30ºC, and their weight measured to be 204 g.

1.5 g of Rhizopus oligosporus was added to the blanched lupin fragments and mixed through, after which the lupin fragments were placed in a perforated plastic bag and then incubated at approximately 30ºC and 50% relative humidity for 26 hours. The resultant fermented food product in the form of a lupin consumable was removed and chilled and a nutritional analysis performed. The results of this analysis are set out in Table 1 below.

TABLE 1
Nutritional values of the fermented lupin consumable of Example 1

| Ingredients | | |
|---|---|---|
| Lupin | | 48.4% |
| Water | | 48.4% |
| Vinegar | | 2.2% |
| Rhizopus | | <1% |
| Nutritional per 100 g | | |
| Energy - kJ | | 511.5 |
| Moisture | | 64.7 |
| Protein - g | | 18.1 |
| Fat - g | Total | 2.5 |
| | Saturated | 0.5 |
| | Trans | <0.1 |
| | Poly | 0.5 |
| | Mono | 1.4 |
| Carbohydrate - g | | 0.6 |
| | Sugars | 0.5 |
| Fibre | | 12.7 |
| Ash | | 1.2 |
| Sodium - mg | | 2.5 |

The lupin consumable product described above had a pleasing mouthfeel and taste, and was also found to have good functionality during subsequent food processing. The product retained its form during cooking and did not crumble when cut.

By way of comparison, the process described above was followed but using whole lupin kernels. The resultant fermented product had unpleasant organoleptic properties, was difficult to cut and tended to fall apart during some cooking situations.

Also by way of comparison, the process described above was followed but using lupin kibbles, obtained from a commercial source. The resultant fermented product also had some unpleasant organoleptic properties, with a grainy texture.

### Example 2

The following example describes an alternative method used to produce a lupin fermented product.

Dehulled and Sweet white (albus) lupins were provided in the form of fragments that had been milled into particles having a length of approximately 3500 μm a width of approximately 2250 μm and flattened to a thickness of approximately 700 μm. 100 g of these flattened lupin fragments were immersed in water (95° C.), to which 6 g-10 g of white rice vinegar had been added to adjust the pH to below 4.0, for 20 seconds and then cooked in an oven at 100° C. and 100% r/h for 6 minutes.

The lupin fragments were then cooled to 30° C., after which 1.5 g of Rhizopus oligosporus was added to the cooked lupin fragments and mixed through, after which the lupin fragments were placed in a perforated plastic bag and then incubated at approximately 30° C. and 65% relative humidity for 26 hours. The resultant fermented food product in the form of a lupin consumable was removed and chilled and a nutritional analysis performed. The results of this analysis are set out in Table 2 below.

TABLE 2
Nutritional values of the fermented lupin consumable of Example 2

| Ingredients | | |
|---|---|---|
| Lupin | | 48.4% |
| Water | | 48.4% |
| Vinegar | | 2.2% |
| Rhizopus | | <1% |
| Nutritional per 100 g | | |
| Energy - kJ | | 695 |
| Moisture | | 55.2 |
| Protein - g | | 20.6 |
| Fat - g | Total | 4.3 |
| | Saturated | 0.7 |
| | Trans | <0.1 |
| | Poly | 1.1 |
| | Mono | 2.4 |
| Carbohydrate - g | | 5.5 |
| | Sugars | 1.6 |
| Fibre | | 11.5 |
| Ash | | 1.8 |
| Sodium - mg | | 6.1 |

### Example 3

Dehulled and Sweet white (albus) lupins, milled to fragments of approximately 3500 μm in length by approximately 2250 μm in width and flattened to approximately 950 μm in thickness, were measured to 200 g. 12-20 g of white rice vinegar was added to boiled water to adjust the pH to below pH: 4.0, after which the lupin fragments were added and blanched in the boiling water for 5 minutes 30 seconds (ensuring that the pH remained below pH: 4.7)

The cooked lupin fragments were then squeezed to expel excess water, to a weight of 430 g. The lupin fragments were then air-dried to approximately 30ºC and a weight of 410 g.

2.5 g of Rhizopus oligosporus starter was added to the blanched lupin fragments and mixed through. At the same time, spices (1.5 g turmeric, 2.5 g paprika, 2.5 g onion powder, 0.5 g dried thyme) were added to the blanched lupin fragments and mixed through. The lupin fragments were then placed in perforated silicon moulds mimicking the shape of a sausage and then incubated at approximately 30° C. and 50% relative humidity for 26 hours. The fermented lupin consumable was removed and cooled to room temperature before being fried. The resultant cooked product was visually similar to a cooked sausage, had naturally browned during cooking and had a very pleasant, even textured mouthfeel. Indeed, it tasted like sausage throughout the entirety of the product.

### Example 4

Dehulled mung beans, milled to fragments of approximately 3500 μm in length by approximately 2250 μm in width and flattened to approximately 950 μm in thickness, were measured to 200 g. These flattened bean fragments were immersed in water (95° C.), to which 6 g-10 g of white rice vinegar had been added to adjust the pH to below 4.0, for 20 seconds and then cooked in an oven at 100° C. and 100% r/h for 6 minutes.

The cooked mung bean fragments were then cooled to 30° C., after which 2.5 g of Rhizopus oligosporus starter was added to the bean fragments and mixed through. At the same time, spices (1.5 g turmeric, 2.5 g paprika, 2.5 g onion powder, 0.5 g dried thyme) were added to the bean fragments and mixed through. The bean fragments were then placed in perforated silicon moulds mimicking the shape of a sausage and then incubated at approximately 30° C. and 50% relative humidity for 26 hours. The fermented mung bean consumable was removed and cooled to room temperature before being fried. The resultant cooked product was visually similar to a cooked sausage, had naturally browned during cooking and had a very pleasant, even textured mouthfeel.

### Example 5

200 g of dehulled and Sweet white (albus) lupins were milled into fragments of approximately 3500 μm in length by approximately 2250 μm in width and flattened to approximately 950 μm in thickness. 12-20 g of white rice vinegar was added to boiled water to adjust the pH to below pH: 4.0, after which the lupin fragments were blanched in the boiled water for 5 minutes 30 seconds, ensuring that the pH remained below pH: 4.7. The part-cooked lupin fragments were then squeezed to expel excess water, resulting in a weight 430 g. The lupin fragments were then air-dried to approximately 30ºC, having a final weight of 410 g.

2.5 g of Rhizopus oligosporus starter was added to the blanched lupin fragments and mixed through. Spices (2.5 g onion powder, 2 g garlic powder, 1.5 g yeast extract, 1 g salt) were also added to the blanched lupin fragments and mixed through. The lupin fragments, spice and fungus starter were then placed in perforated plastic bags and incubated at approximately 30ºC and 50% relative humidity for 26 hours.

The resultant fermented lupin consumable was removed and cooled to room temperature before being cut into 2 cm cubes, coated in corn flour, vegan egg replacement and seasoned panko bread crumbs. The product was then lightly pan fried in vegetable oil, to produce cubes having a crunchy outer and soft, moist, textured inside, similar in appearance to chicken nuggets. The products had a flavour very much like chicken, throughout its entirety.

### Example 6

150 g of dehulled and Sweet white (albus) lupins were milled into fragments of approximately 3500 μm in length by approximately 2250 μm in width and flattened to approximately 950 μm in thickness. 9-15 g of white rice vinegar was added to boiled water to adjust the pH to below pH: 4.0, after which the lupin fragments were blanched in the boiled water for 5 minutes 30 seconds, ensuring pH remained below pH: 4.7. The part-cooked lupin fragments were then squeezed to expel excess water, resulting in a weight of 320 g, after which that were air-dried to approximately 30ºC and final weight of 307 g.

2 g of Rhizopus oligosporus starter was added to the blanched lupin fragments and mixed through. 4 g of sieved beetroot powder was also added to the blanched lupin fragments and mixed through. Finally, 2 g of dried parsley was added to the blanched lupin fragments and mixed through.

The lupin fragments were placed in perforated silicon burger moulds and then incubated at approximately 30ºC and 50% relative humidity for 26 hours. Fermented lupin consumable was removed and cooled to room temperature before being fried. The product's colour was pink inside pre-cooking and browned during cooking, with flecks of white that resembled fat in meat. The product held its shape very well during cooking and had a mildly meaty flavour and a texture similar to a minced meat burger.

### Example 7

Dehulled and Sweet white (albus) lupins, milled to fragments of approximately 3500 μm in length by approximately 2250 μm in width by approximately 950 μm in thickness, were measured to 95 g. 5 g of quinoa was then added to the lupin fragments and mixed thoroughly.

6 g-10 g of white rice vinegar was added to boiled water to adjust the pH to below pH: 4.0, after which the lupin fragments/quinoa blend were blanched in the boiled water for 5 minutes 30 seconds, ensuring pH remained below pH: 4.7. The part-cooked solids were squeezed to expel excess water, to a weight 214 g before the lupin fragments/quinoa blend were air-dried to approximately 30ºC and a weight of 204 g.

1.5 g of Rhizopus oligosporus was added to the blanched lupin fragments/quinoa blend and mixed through, after which the lupin fragments/quinoa blend was placed in a perforated plastic bag and then incubated at approximately 30° C. and 50% relative humidity for 26 hours. The resultant fermented lupin consumable was removed and chilled, before being cut into strips of approximately 5 mm thickness and pan fried in vegetable oil. The appearance of the cooked product was golden brown, and it had a mild meaty flavour and complex even texture.

### Example 8

The following example describes a method used to produce a soybean fermented product.

Dehulled soybeans were provided in the form of fragments that had been milled into particles having a length of approximately 2900 μm a width of approximately 2100 μm and flattened to a thickness of approximately 1200 μm. 100 g of these flattened soybean fragments were immersed in water (95° C.), to which 6 g-10 g of white rice vinegar had been added to adjust the pH to below 4.0, for 235 seconds and then cooked in an oven at 100° C. and 100% r/h for 8 minutes.

The cooked soybean fragments were then cooled to 30° C., after which 1.5 g of Rhizopus oligosporus was added to the cooked lupin fragments and mixed through, after which the soybean fragments were placed in a perforated plastic bag and then incubated at approximately 30° C. and 65% relative humidity for 26 hours. The resultant fermented soybean product in had a very pleasant, even textured mouthfeel.

Embodiments of the present invention may have one or more of the following advantages:
fermented pulse-containing food products having the nutritional benefits of the pulses can provide an alternative to other food products (plant and meat-based);
the fermented food products can be produced in a shorter timeframe than for conventional tempeh and other solid state fermentations, but without sacrificing nutritional or organoleptic quality;
a highly nutritious and versatile food product is produced from sustainable plant-based materials, which is better from an environmental perspective; and
the organoleptic properties and functionality of the food products provide an unprecedented versatility for subsequent use.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for producing a fermented food product from a pulse, the method comprising the steps of:
cooking the pulse, wherein the pulse is provided in the form of flattened pulse fragments;
fermenting the cooked flattened pulse fragments under conditions whereby the fermented food product is produced.

2. The method of claim 1, wherein the flattened pulse fragments have a thickness of between about 0.5 mm and about 1.3 mm.

3. The method of claim 1, wherein the flattened pulse fragments have a length of between about 2.5 mm and about 7 mm and a width of between about 1.5 mm and about 5 mm.

4. The method of claim 1, wherein the flattened pulse fragments are cooked by blanching.

5. The method of claim 1, wherein the flattened pulse fragments are cooked by heating in an oven to about 100° C. and at about 100% relative humidity.

6. The method of claim 1, wherein fermentation is caused by adding a fermentation starter to the cooked flattened pulse fragments.

7. The method of claim 6, wherein the fermentation starter is selected from one or more of the group consisting of: Rhizopus oligosporus, Rhizopus oryzae, Rhizopus arrhizus and Rhizopus stolonifer.

8. The method of claim 6, wherein the fermentation starter and the cooked flattened pulse fragments are blended.

9. The method of claim 1, wherein fermentation occurs for between about 22 hours and about 30 hours.

10. The method of claim 1, wherein fermentation occurs at a temperature of about 30° C.

11. The method of claim 1, wherein fermentation occurs at a humidity of about 45-80%.

12. The method of claim 1, wherein fermentation occurs in a mould.

13. The method of claim 1, further comprising adding a pH reducing agent pre-fermentation.

14. The method of claim 13, wherein the pH reducing agent is white rice vinegar.

15. The method of claim 1, wherein the pulse is selected from one or more of the group consisting of: lupins, soyabeans, chickpeas, lentils, beans, peas and peanuts.

16. The method of claim 1, further comprising adding a colourant.

17. The method of claim 1, further comprising adding a flavourant.

18. The method of claim 1, wherein one or more seeds selected from the following group are blended into the fermented food product: quinoa, amaranth, buckwheat, pumpkin seeds, hemp seeds and sunflower seeds.

19. A fermented food product produced by the method of claim 1.

20. A food product including a fermented food product produced by the method of claim 1.

21. A fermented food product comprising fermented flattened pulse fragments.
